(19) United States
(12) Patent Application Publication
(10) Pub. No.: US 2005/0056256 A1
(43) Pub. Date: Mar. 17, 2005

(54) Fuel manifold in thixotropic aluminum for the direct injection of fuel into an internal combustion engine

(76) Inventors: Renzo Moschini, Bologna (IT); Gianluca Mattogno, Frascati (IT); Flavio Giovannini, Casalecchio Di Reno (IT); Stefano Poggi, Sala Bolognese (IT); Mario Casari, San Giovanni In Persiceto (IT)

Correspondence Address: BAKER & DANIELS;111 E. WAYNE STREET, SUITE 800, FORT WAYNE, IN, 46802, US

(21) Appl. No.: 10/817,221

(22) Filed: Apr. 2, 2004

(30) Foreign Application Priority Data
Apr. 4, 2003 (IT) BO2003A000200

(51) Int. Cl. F02M 1/00

(52) U.S. Cl. 123/456

(57) ABSTRACT

A fuel manifold for the direct injection of fuel into an internal combustion engine comprising a head provided with a number of cylinders, a number of injectors, each of which is connected to the fuel manifold and is adapted directly to inject the fuel into a respective cylinder, and an intake manifold, which is connected to the head in order to supply fresh air to the cylinders, the fuel manifold being formed by a single monolithic body which is made from thixotropic aluminum by means of a pressure die casting process and comprises a supply duct adapted to distribute the fuel to the injectors, and a flange disposed laterally to the supply duct, the flange being adapted to be secured by a plurality of screws to the head of the engine and comprising a number of coupling members each of which is adapted to bring a respective cylinder into communication with the intake manifold.

The present invention relates to a fuel manifold for the direct injection of fuel into an internal combustion engine.

The present invention can be used particularly advantageously for the production of a fuel manifold for the direct injection of petrol into a petrol-driven internal combustion engine to which the following description will explicitly refer without going into detail.

### BACKGROUND OF THE INVENTION

In recent years, petrol-driven internal combustion engines, in which the petrol is injected directly into the cylinders, have come to the fore; in these engines, the petrol is supplied under pressure to a petrol manifold connected to a series of injectors (one for each cylinder of the engine), which are actuated cyclically to inject part of the petrol under pressure in the petrol manifold into a respective cylinder.

In known engines with indirect petrol injection, the petrol manifolds are currently made from plastic material (typically moulded technopolymers) and are secured to the intake manifold, which is also generally made from plastic material, by means of a series of screws. Plastic material is easy to process and extremely economic, but does not have good mechanical properties and is not therefore able to bear the relatively high pressures of the petrol used in direct petrol injection with the necessary safety margins.

In order to ensure the necessary mechanical strength, it has been proposed to use petrol manifolds made from steel in known direct petrol injection engines; these petrol manifolds are nevertheless costly because of the number of machining and welding operations to which they have to be subject. It has also been proposed to use petrol manifolds made from cast aluminum by means of gravity die casting; these petrol manifolds are also costly as gravity die casting is a relatively slow production method, requires a large number of machining operations once the component has been removed from the casting mould and imposes minimum component thicknesses of no less than 4-5 mm.

### SUMMARY OF THE INVENTION

The object of the present invention is to provide a fuel manifold for the direct injection of fuel into an internal combustion engine which is free from the drawbacks described above and is easy and economic to embody.

The present invention therefore relates to a fuel manifold for the direct injection of fuel into an internal combustion engine as set out in claim 1 and, preferably, any one of the subsequent claims dependent directly or indirectly on claim 1.

### BRIEF DESCRIPTION OF THE DRAWINGS

The present invention will now be described with reference to the accompanying drawings, which show a non-limiting embodiment thereof, and in which:

FIG. 1 is a diagrammatic view of an internal combustion engine with direct petrol injection provided with a fuel manifold in accordance with the present invention;

FIG. 2 is a perspective view of a preferred embodiment of the fuel manifold of FIG. 1;

FIG. 3 is a front view of the fuel manifold of FIG. 2;

FIG. 4 is a view in section along the line IV-IV of the fuel manifold of FIG. 2 coupled to the head of the engine of FIG. 1.

### DETAILED DESCRIPTION OF THE INVENTION

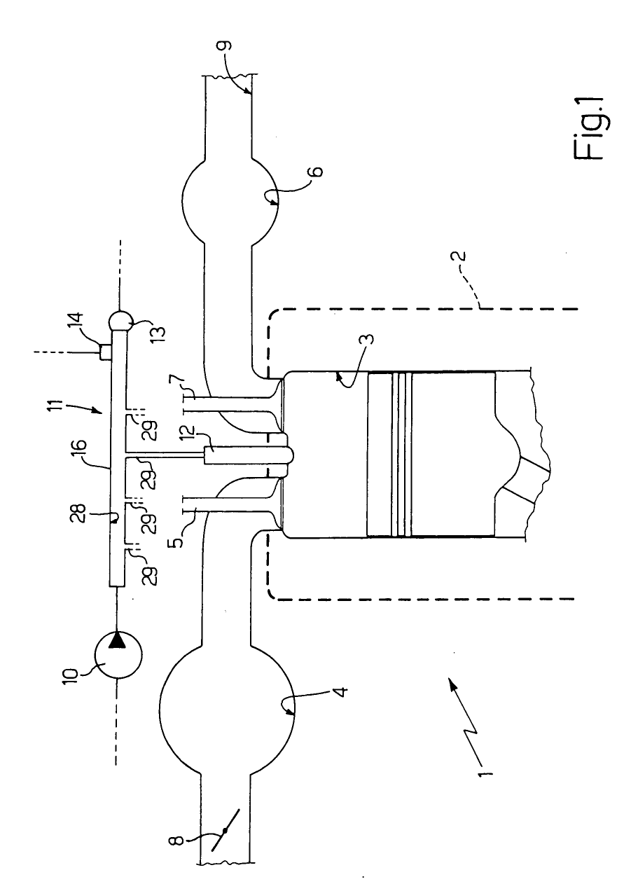

In FIG. 1, an internal combustion engine is shown overall by 1 and comprises a head 2 in which four cylinders 3 are provided (only one of which is shown in FIG. 1), each of these cylinders 3 being connected to an intake manifold 4 by means of at least one respective intake valve 5 and to an exhaust manifold 6 by means of a respective exhaust valve 7. The intake manifold 4 receives fresh air (i.e. ambient air from outside) by means of a butterfly valve 8 which can be adjusted between a closed position and a position of maximum opening; an exhaust duct 9 provided with one or more catalysts (not shown in detail) leads from the exhaust manifold 6 for the emission into the atmosphere of the gases generated by combustion in the cylinders 3.

A low pressure pump (not shown in detail) supplies the petrol from a tank (not shown in detail) to a high pressure pump 10 which in turn supplies the petrol to a petrol manifold 11; a series of injectors 12 (one for each cylinder 3) is connected to the petrol manifold 11, each of these injectors 12 being actuated cyclically to inject part of the petrol under pressure in the petrol manifold 11 into the respective cylinder 3. The pressure value of the petrol in the petrol manifold 11 is maintained instant by instant at a desired value by means of a pressure regulator 13 which is coupled to the petrol manifold 11 and is adapted to discharge any surplus petrol to a recycling duct which returns this surplus petrol upstream of the low pressure pump (not shown). A sensor 14, adapted to measure the pressure value of the petrol in the petrol manifold 11, is also connected to the petrol manifold 11.

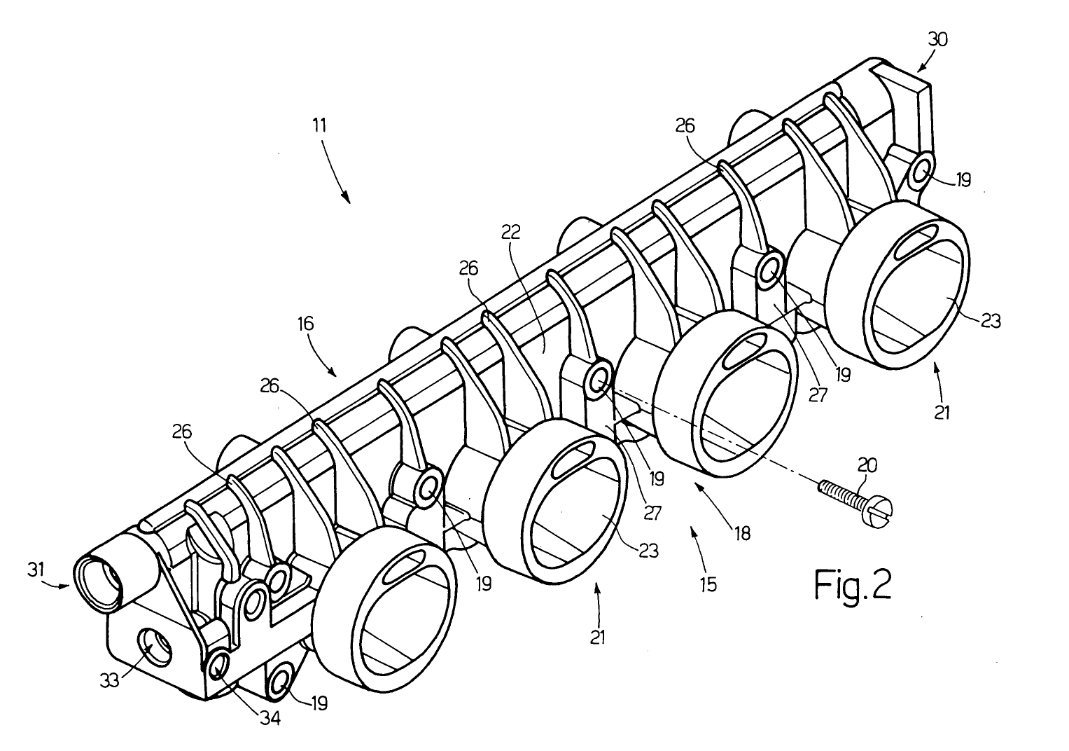

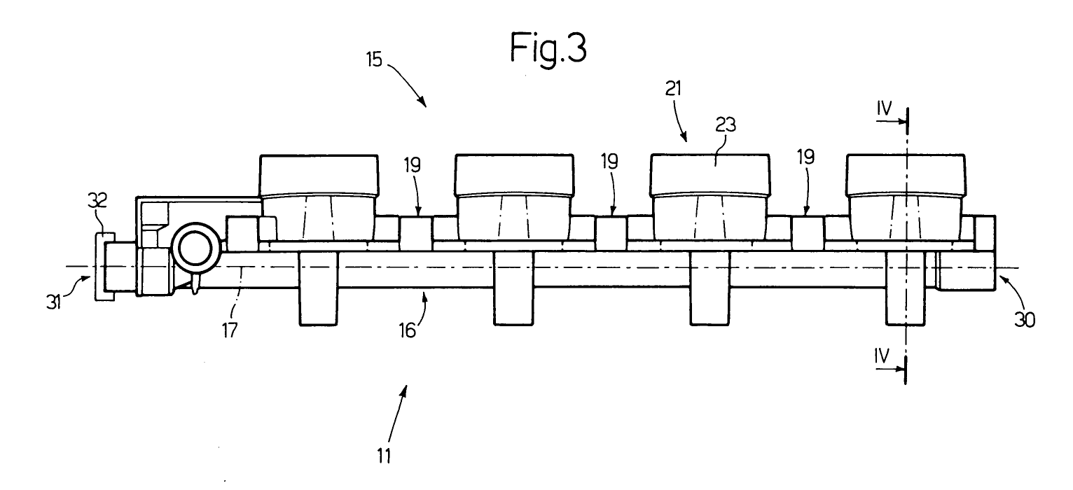

As shown in FIGS. 2 to 4, the fuel manifold 11 is formed by a single monolithic body 15 which is made from thixotropic aluminum by means of a pressure die casting process and comprises a supply duct 16, which is of substantially cylindrical shape, has a central axis of symmetry 17 and is adapted to distribute the petrol under pressure to the injectors 12, and a flange 18 disposed laterally to the supply duct 16. The flange 18 has a plurality of through holes 19 so that it can be secured by respective screws 20 to the head 2 of the engine 1 and comprises four coupling members 21, each of which is adapted to bring a respective cylinder 3 into communication with the intake manifold 4.

The flange 18 comprises a substantially plane plate 22 which extends laterally to the supply duct 16 from a median portion of this supply duct 16; each coupling member 21 comprises a tubular body 23 which rises from the plate 22 in a perpendicular manner with respect to the plane in which the plate 22 lies. Preferably, the end upper portion of each tubular body 23 is shaped to facilitate connection with a respective duct coming from the intake manifold 4. A lower surface 24 of the plate 22, i.e. the opposite surface with respect to the tubular bodies 23, is plane and has a relatively very small surface roughness so that it can be coupled in a leak-tight manner (possibly with the interposition of a gasket) with a corresponding upper surface 25 of the head 2.

A series of reinforcing ribs 26, involving both the plate 22 and the supply duct 16, are provided and are disposed perpendicularly with respect to the plane in which the plate 22 lies and with respect to the axis 17 of the supply duct 16. The flange 18 has a series of raised zones 27, via each of which a respective through hole 19 is provided for the passage of a connection screw 20 with the head 2 of the engine 1. Part of the reinforcing ribs 26 starts from the raised zones 27, while the remaining part of the reinforcing ribs 26 starts from the tubular bodies 23.

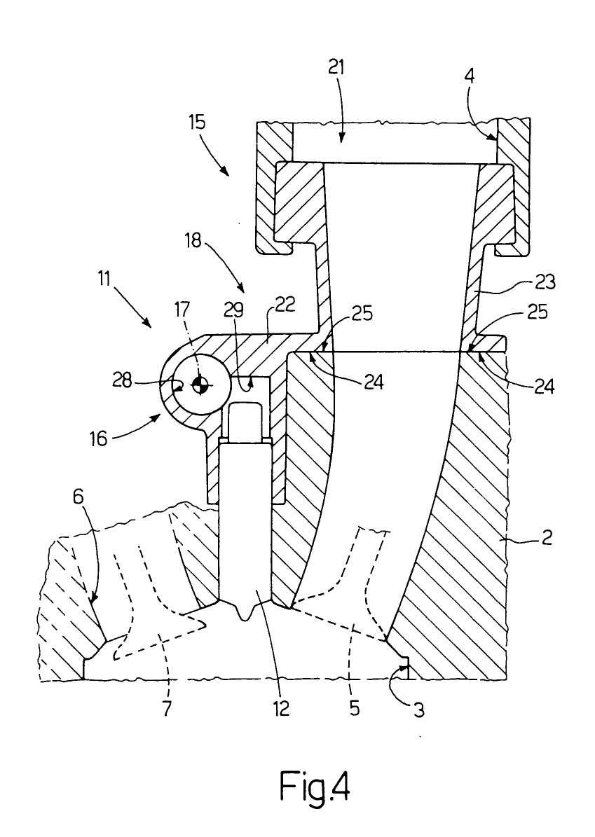

As shown in FIG. 4, the supply duct 16 is formed by a main cylindrical tubular channel 28 from which a series of further secondary cylindrical tubular channels 29, disposed perpendicularly with respect to the main cylindrical tubular channel 28, leads; each secondary cylindrical tubular channel 29 is adapted to house a respective injector 12 in a leak-tight manner. The main cylindrical tubular channel 28 has two opposite open ends 30 and 31, the end 30 being connected to the high pressure pump 10 in order to supply the petrol under pressure to the petrol manifold 11, while the end 31 is closed by a relative screw cap 32. The function of the end 31 is to enable the correct production of the main cylindrical tubular channel 28 during the pressure die casting process for the monolithic body 15. In the vicinity of the end 31, the main cylindrical tubular channel 28 has an opening 33 adapted to receive the pressure regulator 13 and an opening 34 adapted to receive the pressure sensor 14. Preferably, the openings 33 and 34 are not formed during the pressure die casting process for the monolithic body 15, but are produced subsequently by drilling of the monolithic body 15. Various experimental tests have shown that the petrol manifold 11 described above is particularly simple and economic to produce and at the same time manages to work extremely safely with petrol supply pressures of close to 130 bar.

1. A fuel manifold for the direct injection of fuel into an internal combustion engine comprising a head provided with a number of cylinders, a number of injectors, each of which is connected to the fuel manifold and is adapted directly to inject the fuel into a respective cylinder, and an intake manifold which is connected to the head in order to supply fresh air to the cylinders, the fuel manifold being characterised in that it is formed by a single monolithic body which is made from thixotropic aluminum by means of a pressure die casting process and comprises a supply duct adapted to distribute the fuel under pressure to the injectors, and a flange disposed laterally to the supply duct, the flange having a plurality of through holes in order to be secured by respective screws to the head of the engine and comprising a number of coupling members, each of which is adapted to bring a respective cylinder into communication with the intake manifold.

2. A fuel manifold as claimed in claim 1, in which the flange comprises a substantially plane plate which extends laterally to the supply duct from a median portion of this supply duct, each coupling member comprising a tubular body which rises from the plate perpendicularly with respect to the plane in which this plate lies.

3. A fuel manifold as claimed in claim 2, in which a lower surface of the plate is plane and has a relatively very small surface roughness so that is can be coupled in a leak-tight manner with a corresponding upper surface of the head.

4. A fuel manifold as claimed in claim 2, in which a series of reinforcing ribs are provided and are disposed perpendicularly with respect to the plane in which the plate lies and involve both the plate and the supply duct.

5. A fuel manifold as claimed in claim 4, in which the flange has a series of raised zones, via each of which a respective through hole is provided for the passage of a screw for connection to the head of the engine.

6. A fuel manifold as claimed in claim 5, in which some reinforcing ribs start from the raised zones.

7. A fuel manifold as claimed in claim 4, in which some reinforcing ribs start from the tubular bodies.

8. A fuel manifold as claimed in claim 1, in which the supply duct is formed by a main cylindrical tubular channel from which a series of further secondary cylindrical tubular channels, disposed perpendicularly with respect to the main cylindrical tubular duct, lead, each secondary cylindrical tubular channel being adapted to house a respective injector in a leak-tight manner.

9. A fuel manifold as claimed in claim 8, in which the main cylindrical tubular channel has two opposite open ends, one of which is used to supply the fuel under pressure and the other is closed by a relative screw cap.

10. A fuel manifold as claimed in claim 9, in which, in the vicinity of the end closed by the screw cap, the main cylindrical tubular channel has a first opening adapted to receive a pressure regulator and a second opening adapted to receive a pressure sensor.
